(19) United States
(12) Patent Application Publication
(10) Pub. No.: US 2012/0180612 A1
(43) Pub. Date: Jul. 19, 2012

(54) HAND-OPERATED RECIPROCATING SLICER

(75) Inventors: David A. Holcomb, Seattle, WA (US); Adam A. Jossem, Seattle, WA (US)

(73) Assignee: CHEF'N CORPORATION, Seattle, WA (US)

(21) Appl. No.: 13/211,080

(22) Filed: Aug. 16, 2011

Related U.S. Application Data
(60) Provisional application No. 61/433,102, filed on Jan. 14, 2011.

(51) Int. Cl. B26D 7/26; B26D 3/00

(52) U.S. Cl. 83/613

(57) ABSTRACT

A hand operated slicer incorporates a housing, a base, and a reciprocating blade assembly. The housing has a top, opposing lateral sides, a food retaining chamber, and a passageway extending therethrough between the lateral sides and aligned with a cutting plane. The base is coupled to the housing and configured to prevent the housing from moving during typical operation. The reciprocating blade assembly is slidably engaged with the passageway on the housing, and carries a blade that moves through or adjacent the food retaining chamber as the assembly reciprocates, to slice a food item in the chamber. The blade assembly can be adjustable to change the thickness of the slice, and can be convertible to create French fries, make julienne cuts or the like.

This application claims the benefit under 35 U.S.C. §119(e) of U.S. Provisional Patent Application No. 61/433,102 filed Jan. 14, 2011; where this provisional application is incorporated herein by reference in its entirety.

### BACKGROUND OF THE INVENTION

1. Field of the Invention

The present disclosure generally is related to kitchen tools, and more particularly, to tools for slicing food, making julienne cuts and the like.

2. Description of the Related Art

A wide variety of tools exist for cutting food, slicing food, cutting potatoes into French fries, making julienne cuts, and the like. Because a cook typically does all of the above at one time or another, a device that combines some or all of these functions has advantages.

### BRIEF SUMMARY OF THE INVENTION

In one embodiment, hand-operated device, for use in slicing a food item, incorporates a housing, a base, and a blade assembly. The housing has a top, opposing lateral sides, a food receiving chamber, and a passageway extending longitudinally therethrough between the opposing lateral sides. The passageway is aligned with a slicing plane. The food receiving chamber is accessible through the top of the housing, and is configured to at least substantially encircle the food item in the slicing plane. The base is fixedly coupled with respect to the housing to support the housing on a countertop or other surface such that the housing does not move during normal use. The blade assembly has a proximal portion, an opposing distal portion, and an upper surface with a blade thereon. The proximal portion of the blade assembly has a handle. The distal portion of the blade assembly is reciprocally engaged with the passageway in the housing, and the blade assembly is configured to reciprocate with respect to the housing along a slicing stroke oriented longitudinally along the passageway. The blade is located on the upper surface of the blade assembly in a location that passes through or adjacent the food receiving chamber with each stroke of the blade assembly, such that food located in the food receiving chamber is sliced by the blade with each stroke.

In another embodiment, a hand-operated device, for use in slicing a food item, incorporates a housing, a base and a blade assembly. The housing has a top, opposing lateral sides, a food receiving chamber, and a passageway extending longitudinally therethrough between the opposing lateral sides. The passageway is aligned with a slicing plane. The food receiving chamber is accessible through the top of the housing, and is configured to at least substantially encircle the food item in the slicing plane. The base is fixedly coupled with respect to the housing to support the housing on a countertop or other surface such that the housing does not move during normal use. The blade assembly has a proximal portion, an opposing distal portion, a fixed upper surface with a blade thereon, and a movable upper surface. The proximal portion of the blade assembly has a handle. The distal portion of the blade assembly is reciprocally engaged with the passageway, and the blade assembly is configured to reciprocate with respect to the housing along a slicing stroke longitudinally along the passageway. The blade is located on the fixed upper surface of the blade assembly in a location that passes through or adjacent the food receiving chamber with each stroke of the blade assembly. The movable upper surface is movable vertically with respect to the blade assembly to change a vertical distance between the movable upper surface and the blade and, as such, the thickness of the slice of food item cut by the device.

In still other embodiments, a hand-operated device, for use in slicing a food item, incorporates a housing, a base and a reciprocating blade assembly. The housing has a top, opposing lateral sides, a food receiving chamber, and a passageway extending longitudinally therethrough between the opposing lateral sides. The passageway is aligned with a slicing plane. The food receiving chamber is accessible through the top of the housing, and is configured to at least substantially encircle the food item in the slicing plane. The base is fixedly coupled with respect to the housing to support the housing on a countertop or other surface such that the housing does not move during normal use. The blade assembly has a proximal portion, an opposing distal portion, and an upper surface with a blade thereon. The proximal portion of the blade assembly has a handle. The distal portion of the blade assembly is reciprocally engaged with the passageway, configured to reciprocate with respect to the housing along a slicing stroke oriented longitudinally along the passageway. The blade is located on the upper surface of the blade assembly in a location that passes through or adjacent the food receiving chamber with each stroke of the blade assembly. At least a portion of the upper surface is removable and invertable with respect to the blade assembly. The opposing face of the removable and invertable portion of the upper surface has a plurality of blades thereon such that, when it is inverted, the device can make French fry cuts, julienne cuts or the like.

### BRIEF DESCRIPTION OF THE SEVERAL VIEWS OF THE DRAWING(S)

FIGS. 1A through 1C are perspective views of a hand-operated, reciprocating slicer, according to one embodiment.

FIG. 2 is a side elevation view of the slicer of FIG. 1.

FIG. 3 is an end view of the slicer of FIG. 1.

FIG. 4 is a bottom perspective view of the slicer of FIG. 1.

FIG. 5 is a top plan view of the slicer of FIG. 1.

FIG. 6 is a cross-sectional view of the slicer of FIG. 1, viewed along Section 6-6 of FIG. 5.

FIG. 7 is a perspective view of a reciprocating blade assembly from the slicer of FIG. 1, depicted in a storage configuration.

FIG. 8 is a side elevation view of the assembly of FIG. 7.

FIG. 9 is a top plan view of the assembly of FIG. 7.

FIG. 10 is an end view of the assembly of FIG. 7.

FIG. 11 is a cross-sectional view of the assembly of FIG. 7, viewed along Section 11-11 of FIG. 5, depicted with an inverted blade insert.

FIG. 12 is an enlarged view of an actuator on the assembly of FIG. 7, the actuator being in an unlocked configuration and the assembly being in the storage configuration.

FIG. 13 is an enlarged view of the actuator of FIG. 12, the actuator being in a locked configuration and the assembly being in the storage configuration.

FIG. 14 is a perspective view of the assembly of FIG. 7, depicted in an operational configuration.

FIG. 15 is a cross-sectional view of the assembly of FIG. 7, viewed along Section 15-15 of FIG. 5, depicted in the operational configuration.

FIG. 16 is an enlarged view of the actuator of FIG. 12, the actuator being in an unlocked configuration and the assembly being in the operational configuration.

FIG. 17 is an enlarged view of the actuator of FIG. 12, the actuator being in a locked configuration and the assembly being in the operational configuration.

FIG. 18 is a perspective view of the assembly of FIG. 7, depicted in an exchange configuration.

FIG. 19 is an exploded perspective view of the assembly of FIG. 7, depicted in an exchange configuration, with two blade inserts removed therefrom.

FIG. 20 is a cross-sectional view of FIG. 19, viewed along Section 20-20 of FIG. 5.

FIG. 21 is a side perspective view of a housing from the slicer of FIG. 1.

FIG. 22 is an end perspective end view of the housing of FIG. 21.

FIG. 23 is a cross-sectional view of the housing of FIG. 1, viewed along Section 23-23 of FIG. 5.

FIG. 24 is an elevation view of a depressor from the slicer of FIG. 1, depicted in an extended configuration.

FIG. 25 is a cross-sectional view of the depressor of FIG. 24 in the extended configuration, viewed along Section 25-25 of FIG. 5.

FIG. 26 is an elevation view of the depressor of FIG. 24, depicted in a compressed configuration.

FIG. 27 is a cross-sectional view of the depressor of FIG. 24 in the compressed configuration, viewed along Section 27-27 of FIG. 5.

### DETAILED DESCRIPTION OF THE INVENTION

The following detailed description is directed toward devices for slicing food, including julienne cutters, French fry cutters and the like. The following detailed description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments and elements removed therefrom, all without deviating from the spirit of the invention. It is intended that all such modifications fall within the scope of the invention, to the extent any such deviation is within the scope of the associated claims.

Reference throughout this specification to “one embodiment” or “an embodiment” means that a particular feature, structure or characteristic described in connection with the embodiment is included in at least one embodiment of the disclosed methods and structures. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

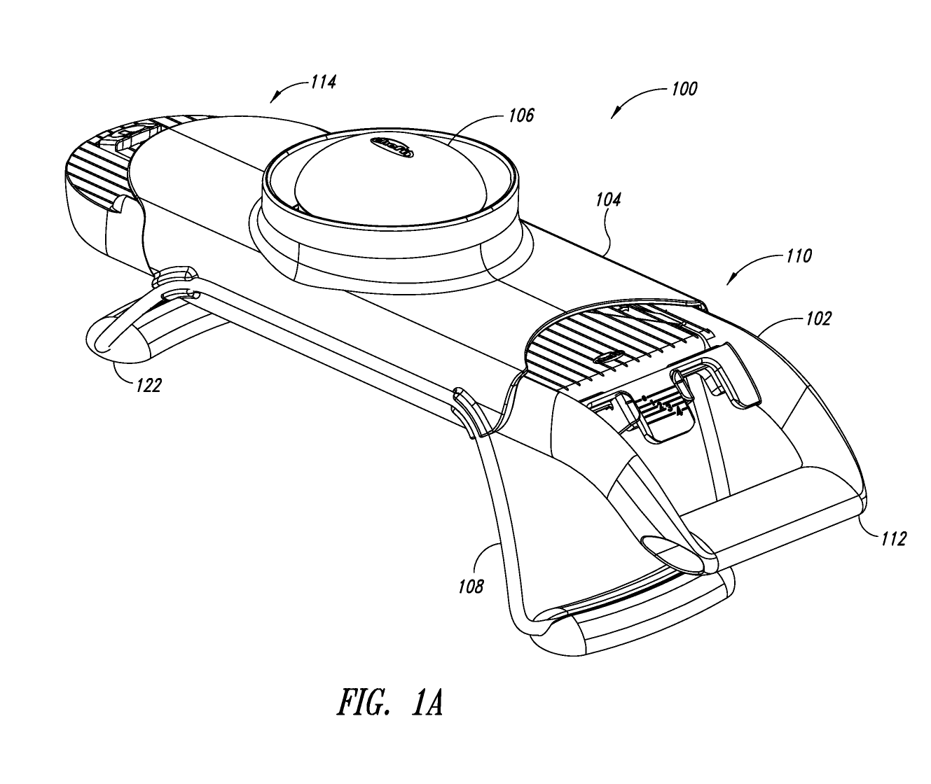

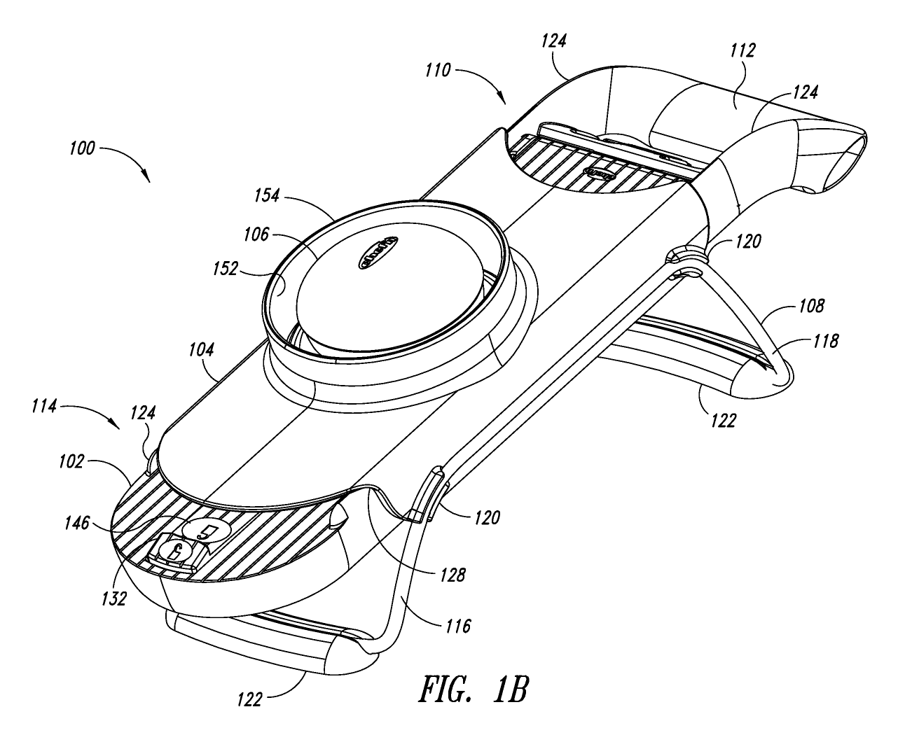

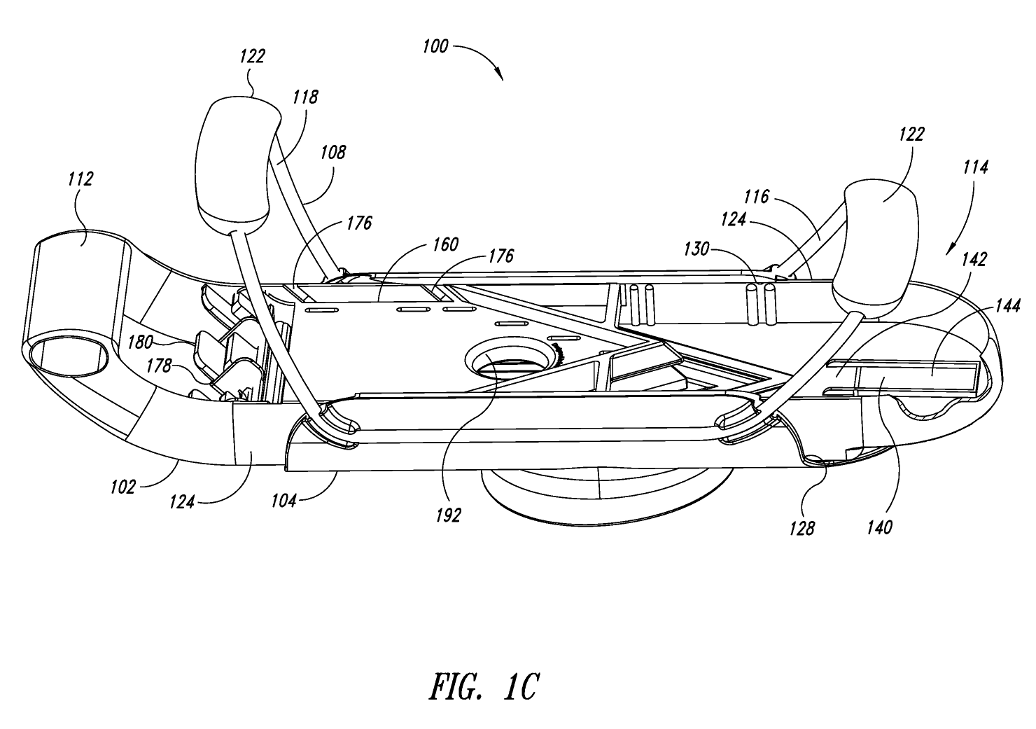

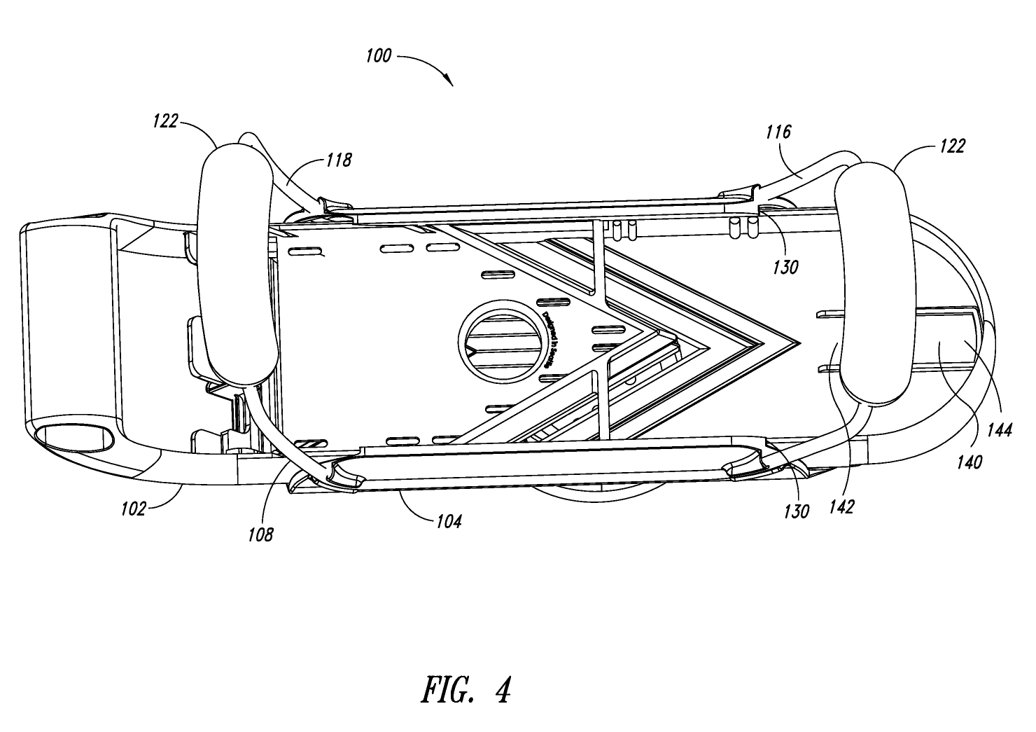

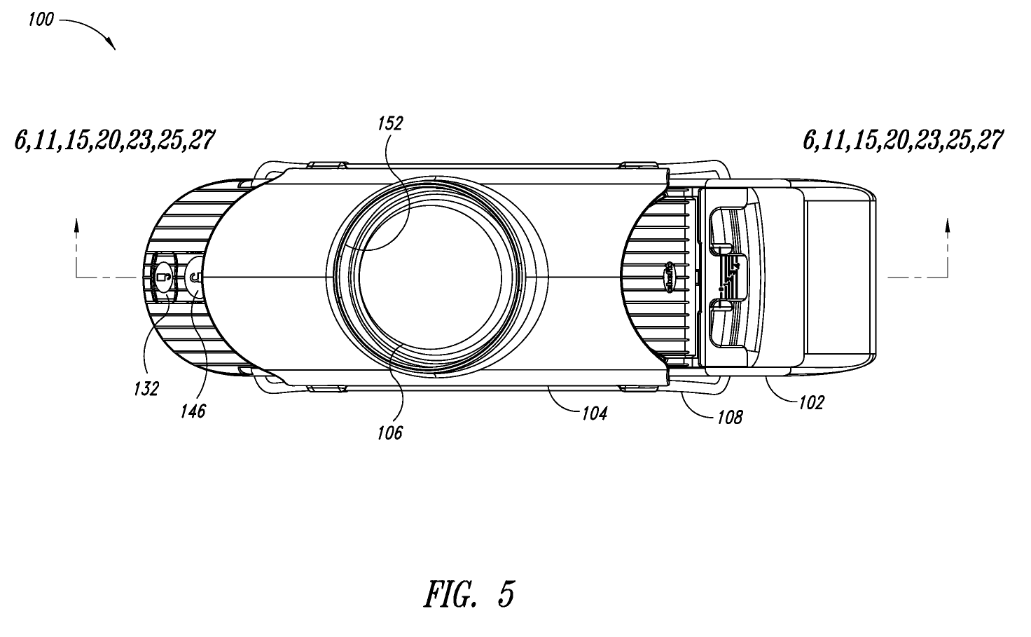

FIGS. 1A-1C and 2-6 illustrate one particular embodiment of a slicing device 100 according to the present invention. The slicing device 100 generally incorporates a reciprocating blade assembly 102, a housing 104, a food depressor 106, and a base 108. The device 100, and each of its elements when assembled, extends longitudinally between a proximal end 110, at which the operator holds a handle 112 on the reciprocating blade assembly 102, and an opposing distal end 114. The illustrated food depressor 106 is located on a top of the device 100 at a central point between the proximal and distal ends 110,114. Generally, during operation the housing 104 and the base 108 remain stationary while the reciprocating blade assembly 102 is repeatedly moved forward and backward with respect to the housing to slice an item of food being urged by the food depressor 106 against a top surface of the blade assembly. A blade in the top surface slices the food item as the blade assembly 102 reciprocates.

The base 108 is attached to the housing 104 to support the device 100 and to maintain the housing in a fixed position and orientation during use. The illustrated base 108 is configured to support the device 100 on a countertop or other surface. In this particular embodiment the base 108 incorporates a pair of front legs 116 located toward the distal end 114 of the device 100, and a pair of rear legs 118 located toward the proximal end 110 of the device. The illustrated front legs 116 are shorter than the rear legs 118 such that the proximal end 110 of the device 100 is elevated above the distal end 114 and the device is angled downward from the rear to the front. This orientation can facilitate use of the device, and can increase comfort and efficiency.

The illustrated base 108 is manufactured from an elongated metal rod bent into a complex shape to form the front legs 116 and the rear legs 118, along with the other sections of the base. A portion of the illustrated base 108 located between the front legs 116 and the rear legs 118 is removably attached to the housing 104 by four pairs of raised fingers 120, one pair of fingers located at the proximal and distal ends of each lateral side of the housing, i.e., one in each corner of the housing. The illustrated base 108 thus is rigidly, yet removably, attached to the housing 104.

The base 108 has a foot 122 at the bottom of each of the front legs 116 and the rear legs 118. In the illustrated embodiment the feet 122 are elongated, with one of the feet extending between the two front legs 116 and another foot extending between the two rear legs 118. The feet 122 are configured to support the device 100 and to prevent the device from moving relative to the support surface during operation. An individual of ordinary skill in the art, having reviewed this entire disclosure, will immediately appreciate that many changes could be made to the base 108, the legs, 116,118 and/or the feet 122, all without deviating from the spirit of the invention. In one particular, alternate embodiment, for example, the base is adapted to rest on the rim of a bowl, allowing the device to slice food directly into the bowl during food preparation.

The blade assembly 102 is adapted to reciprocate longitudinally within and with respect to the housing 104. The blade assembly 102 has a pair of side rails 124 that extend along opposing sides of the blade assembly from a point near the proximal end 110 to a point near the distal end 114. The illustrated side rails 124 are generally smooth and straight and have a constant cross-sectional profile, such that they can slide along their lengths without excessive misalignment or binding. The side rails 124 can be coated, overlaid and/or equipped with other features, such as bearings, wheels, tracks or the like, to improve alignment, reduce friction or otherwise improve performance and/or reduce any likelihood of problems.

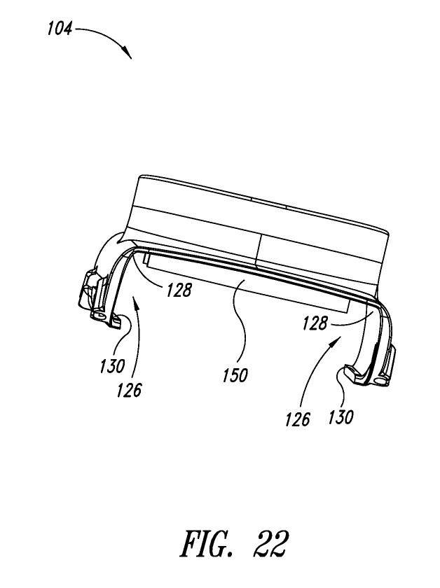

The illustrated housing 104 has a pair of complementary guides 126 that extend along opposing lateral sides of the housing (best illustrated in FIGS. 22 and 23). The side rails 124 on the blade assembly 102 are movable with respect to the housing 104 within the guides 126, each of the side rails being at least partially enclosed, vertically, between an upper guide 128 and a lower guide 130.

The upper guide 128 on each lateral side of the housing 104 complements the size and shape of a corresponding portion of the side rail 124 on the blade assembly 102 to help maintain the vertical position and the alignment of the blade assembly with respect to the housing during use. The upper guide 128 can extend some or all of the length of the guide 126, or can be formed only at the proximal and distal ends thereof, as desired or suitable for the particular design.

The lower guide 130 on each lateral side of the housing 104 generally opposes, vertically, the associated upper guide 128, and it supports the corresponding side of the blade assembly 102. The lower guide 130 is shaped and adapted to allow the side rail 124 to ride thereon during use. The illustrated lower guides 130 are flat and smooth to facilitate a reciprocating sliding motion of the blade assembly 102 during use. The lower guide 130 can be treated, coated or combined with other features to decrease friction and/or misalignment, to increase performance or as otherwise suitable. An individual of ordinary skill in the art, having reviewed this entire disclosure, will immediately appreciate that details can be added, removed and/or changed from the side rails 124 and the guides 126 without deviating from the spirit of the invention.

To reciprocate the illustrated device 100, the operator can set the feet 122 on a countertop, place one hand on the food depressor 106 and the surrounding portion of the housing 104, grab the handle 112 with the other hand, then alternatingly push and pull the blade assembly 102 by the handle. In embodiments where the housing 104 is angled with respect to the surface during use, the operator's hand moves the handle 112 along a line that is vertically angled with respect to the countertop. This movement can be natural and comfortable for the operator.

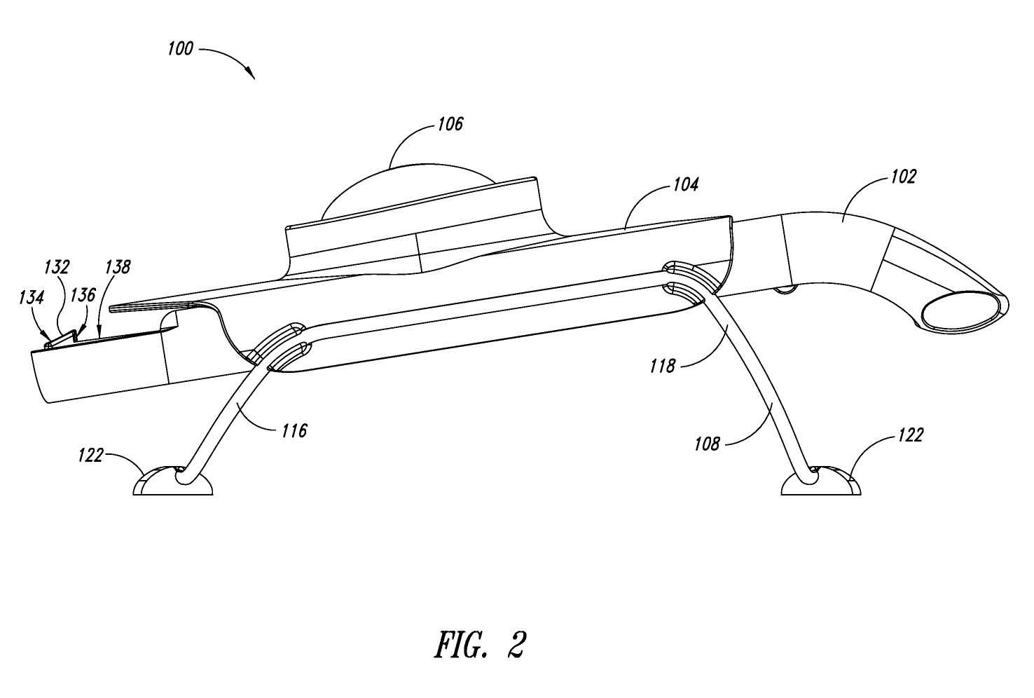

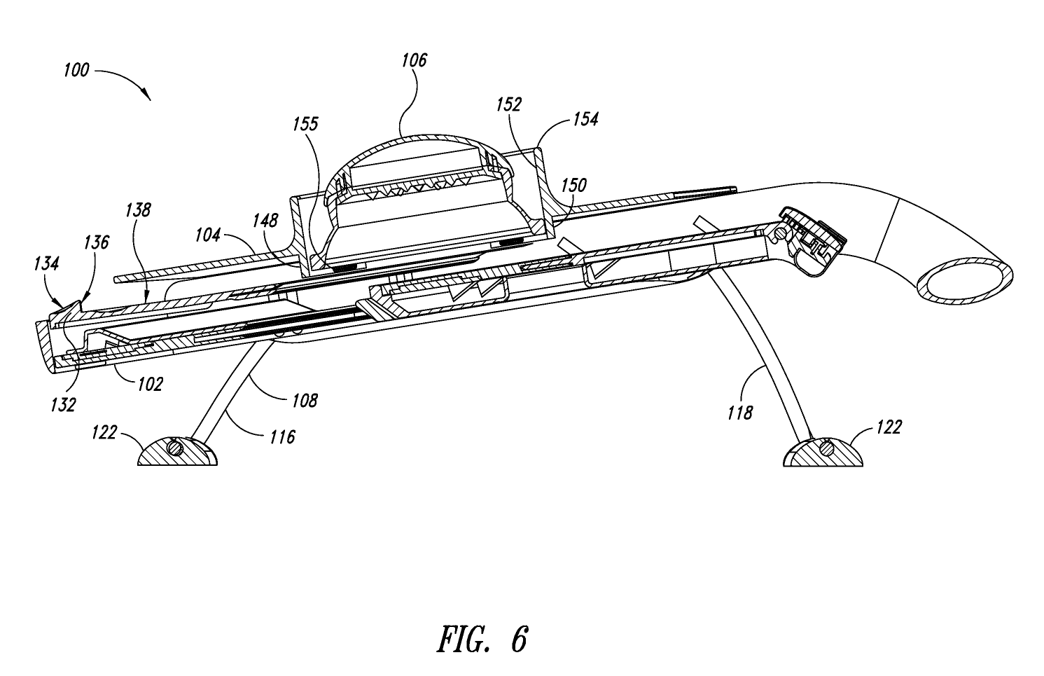

To prevent the blade assembly 102 from unintentionally being moved out of the operating configuration if, for example, an operator were to pull on the handle 112 too long or hard, the illustrated device 100 incorporates a stop 132 near the distal end 114 of the blade assembly 102. The stop 132 is positioned to allow the blade assembly 102 to reciprocate through its entire operating stroke (i.e. the cutting stroke), but to prevent the blade assembly from being pulled beyond the operating configuration. As best seen in FIGS. 2 and 6, the stop 132 has a tapered front surface 134 and a substantially vertical rear surface 136. In its natural, unstressed configuration, the stop 132 projects above a top surface 138 of the blade assembly 102.

The stop 132 is formed on a cantilever 140 of resilient material. A cantilever base 142 at a proximal-most end of the cantilever 140 is fixed to the top surface 138 of the blade assembly 102. In the illustrated embodiment, the cantilever base 142 is formed from the same, unitary section of material as the adjacent top surface 138, and the cantilever 140 merely extends therefrom. A tip 144 at a distal end of the cantilever is unrestricted, such that the tip 144 of the cantilever 140 is free to flex with respect to the surface 138. In the illustrated embodiment, a button 146 on the top of the surface 138, centrally located along the length of the cantilever 140, is formed to identify for the operator one location where the cantilever can be depressed to cause the stop 132 to recess below the level of the top surface 138. As described below, depressing the button 146 on the cantilever 140 can cause the cantilever 140 to bend and can de-activate the stop 132. When the button 146 is released, the resilient material of the cantilever 140 returns to its unstressed state and the stop 132 returns to its original position. In alternate embodiments, the stop 132 can be attached to the cantilever 140 or otherwise formed, assembled or manufactured, and the cantilever can be replaced by a lever and spring combination or other suitable structure. An individual of ordinary skill in the art, having reviewed this entire disclosure, will immediately appreciate that these and other modifications can be made without deviating from the spirit of the invention.

A lower front wall 148 of the housing 104 projects downward from the housing and obstructs movement of the stop 132 beyond a point when the blade assembly 102 reaches the end of its rearward operating stroke. The lower front wall 148 is illustrated in FIGS. 6 and 23. To move the stop 132 beyond the lower front wall 148, the user can depress the button 146 with a finger on one hand and pull the handle 112 with the other hand. The blade assembly 102 is now in a configuration that can be used for blade configuration changes, as all but the distal end 114 of the blade assembly projects proximally beyond the housing 104, exposing the upper surface 138 of a substantial portion of the blade assembly. To return the blade assembly 102 to the operating configuration, the operator can merely push the handle 112; the stop 132 can pass under the lower front wall 148 because the sloped front surface 134 slides along the lower front wall, causing the cantilever 140 to bend and allow the stop to pass. When the stop 132 has passed the lower front wall 148, the cantilever 140 and the stop spring back to the unstressed configuration.

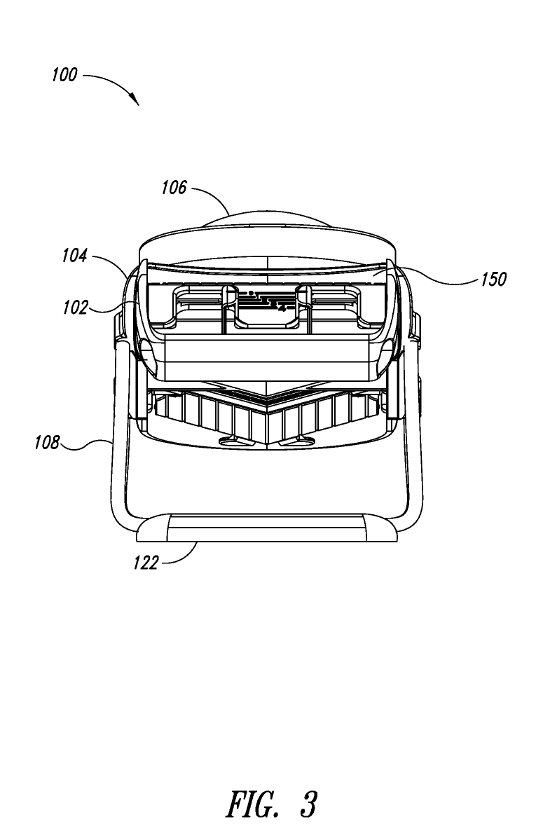

A lower rear wall 150 also projects downward from the housing 104 on an opposing, proximal, side of the food depressor 106. The lower rear wall is illustrated in FIGS. 3, 22 and 23. The lower rear wall 150 obstructs excessive proximal movement of the stop 132 when the blade assembly 102 has been partially removed from the device 100 during blade configuration changes, as discussed in detail above. To completely remove the blade assembly 102 from the device 100, the operator can depress the button 146 and pull the handle 112, as described in detail above. Reinserting the blade assembly 102 into the device 100 is completed as discussed above: by merely urging the sloped front surface 134 of the stop 132 against the lower rear wall 150.

The illustrated lower front wall 148 and lower rear wall 150 combine to form a lower portion of a circular wall 152 around an article of food being processed by the device 100, and can hold the food item stationary during operation, against the force of a blade as the blade slices the food. The circular wall 152 terminates at its upper end in a mouth 154, into which the operator can place food items to be processed by the device 100 (after removing the food depressor 106 therefrom). After the food item is placed in the mouth 154, the food depressor 106 can be used to urge the food item against the blade assembly 102 during use. As illustrated in FIGS. 6 and 23, protuberances 155 are positioned near a lower edge of the circular wall 152. The protuberances 155 can prevent the food depressor 106 from contacting the blade assembly 102 during operation. An individual of ordinary skill in the art, having reviewed this entire disclosure, will immediately appreciate that changes can be made to the circular wall 152 and associated structures without deviating from the spirit of the invention.

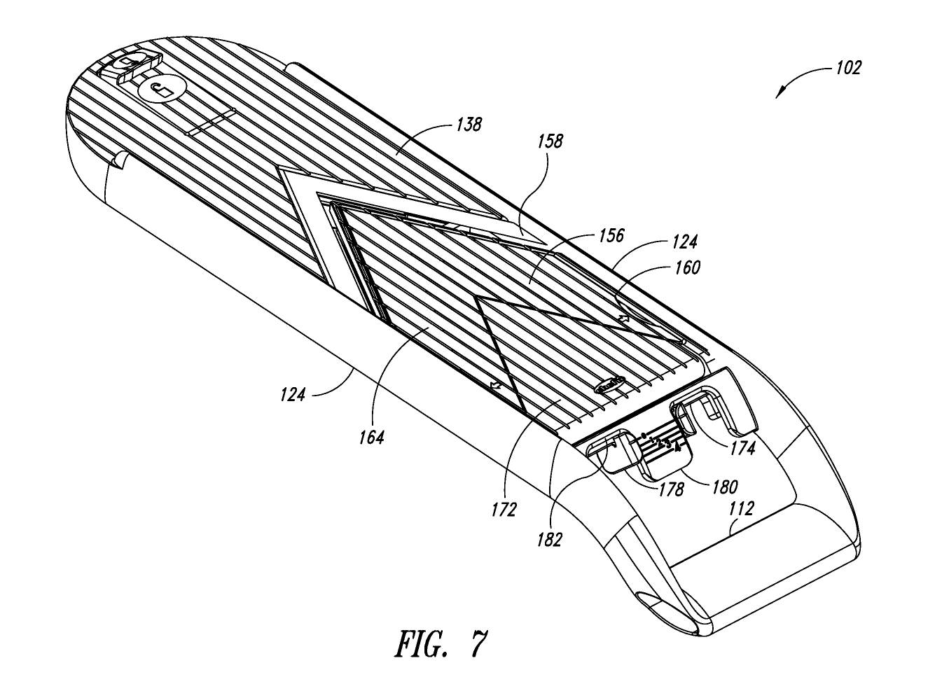

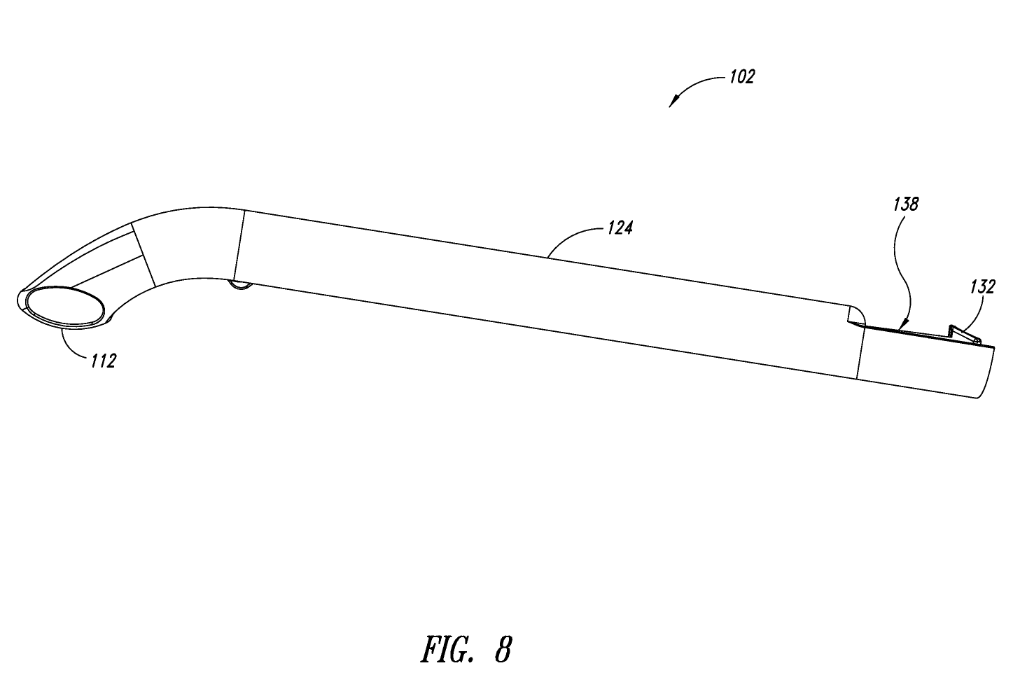

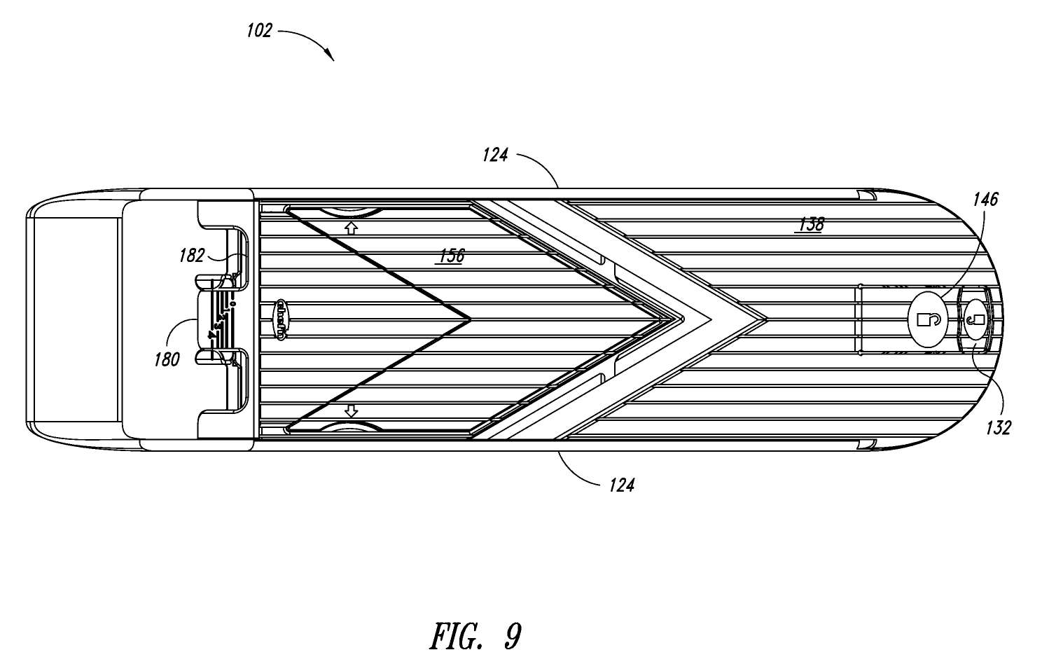

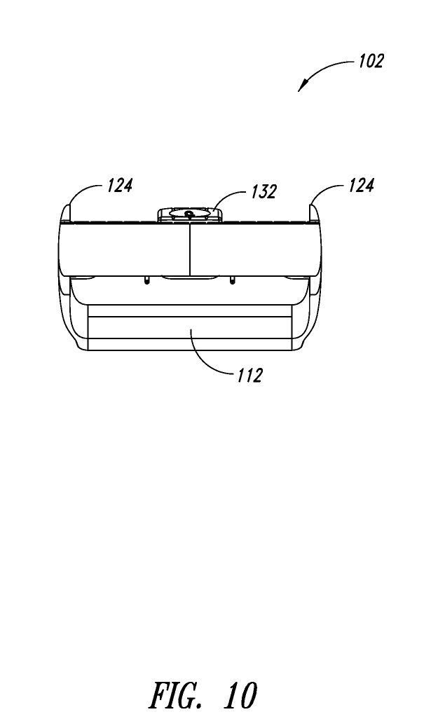

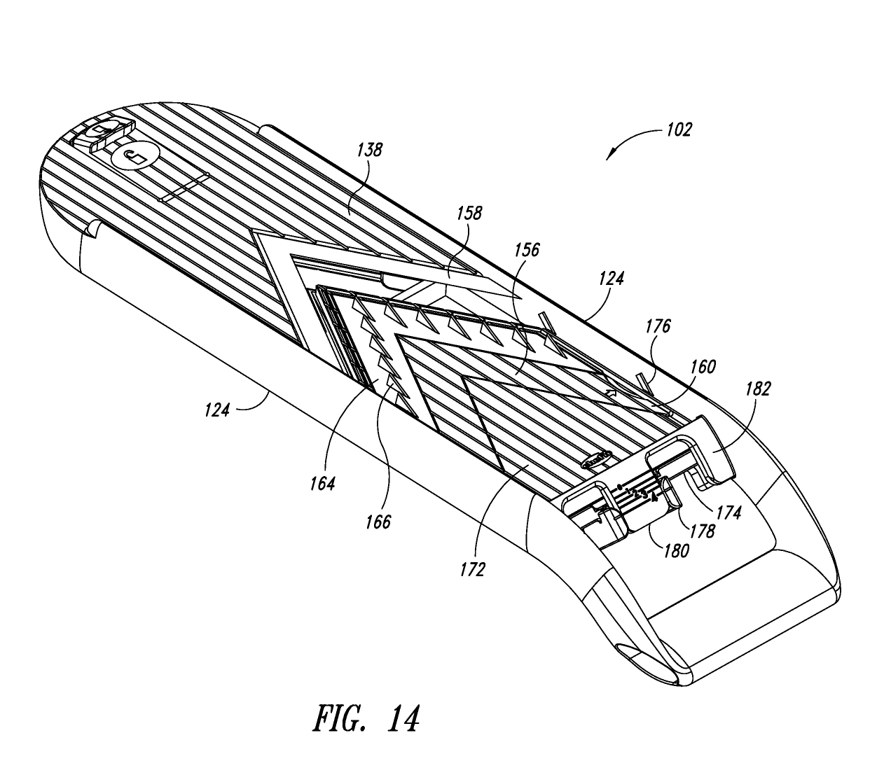

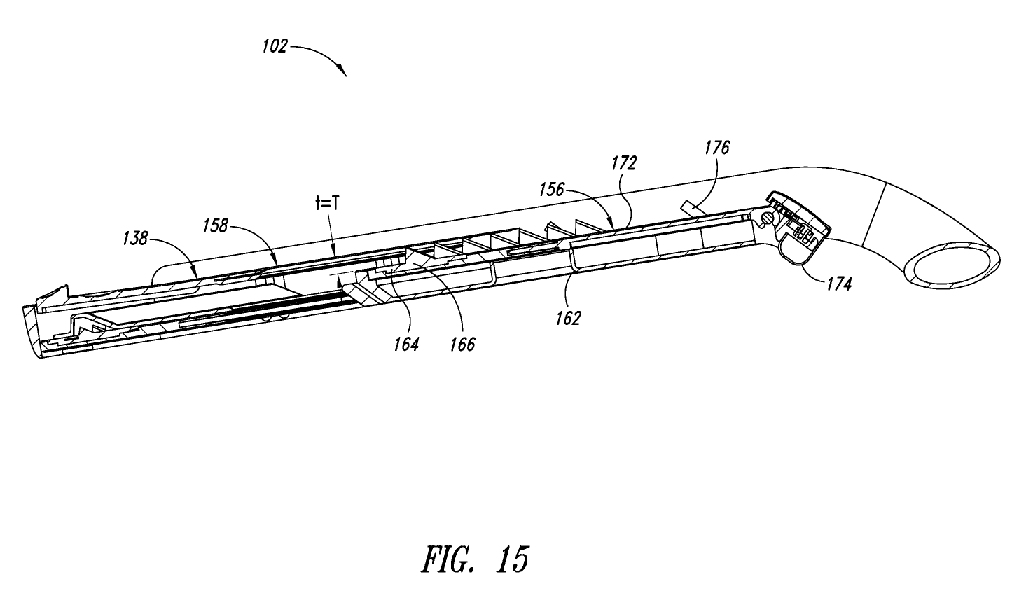

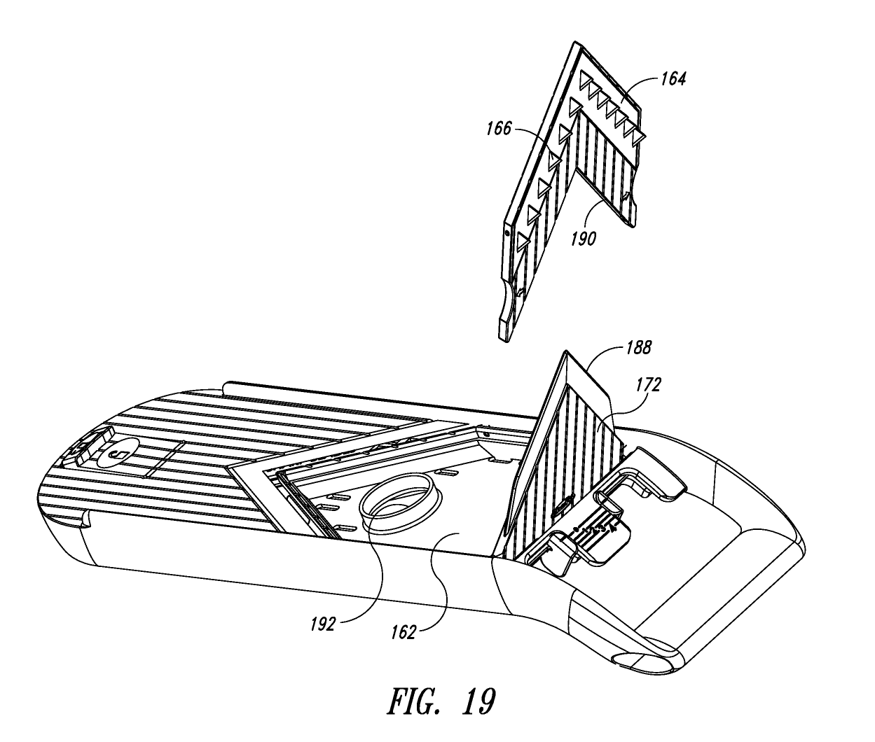

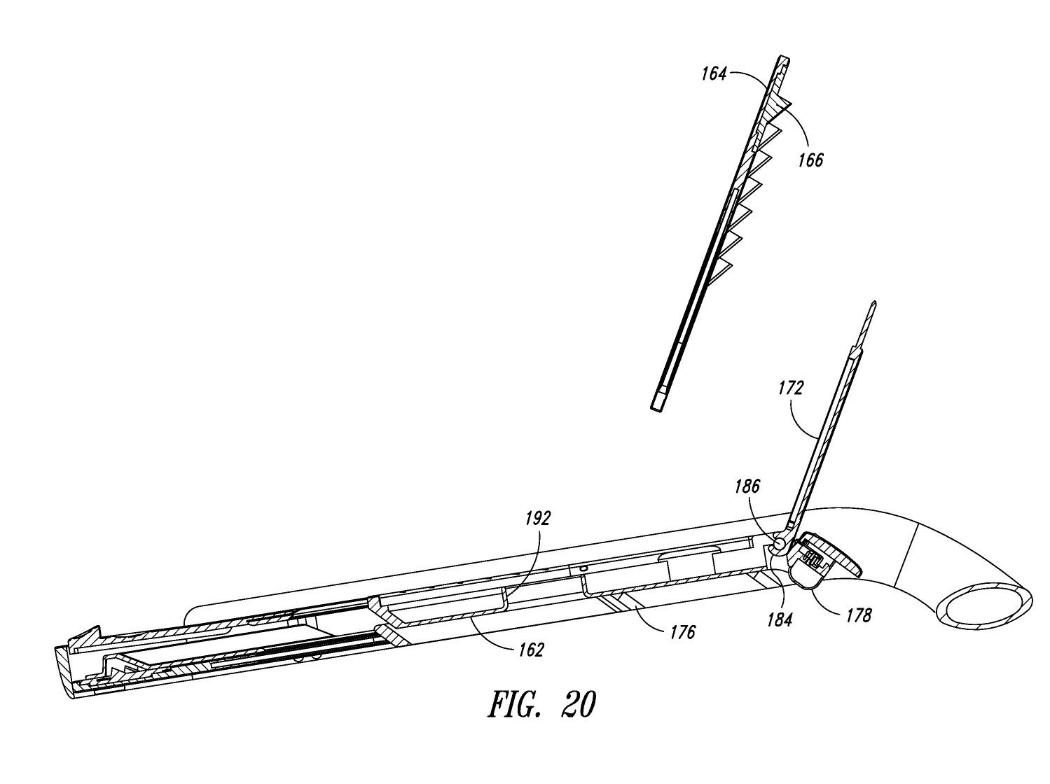

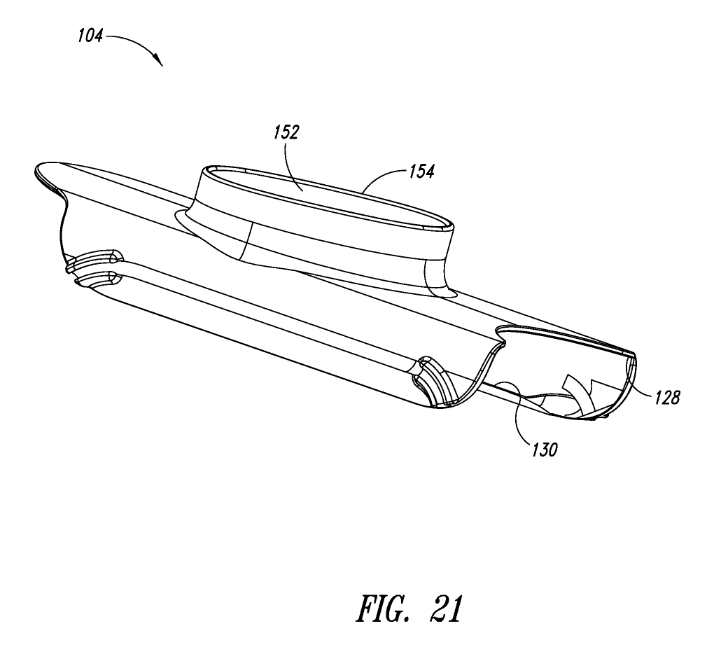

FIGS. 7-20 further illustrate the blade assembly 102, the mechanisms for adjusting the slicing thickness of the device 100, and the mechanisms for replacing some of the functional components of the device. Generally, FIGS. 7 and 11 best illustrate the blade assembly 102 in a storage configuration, when the device 100 is configured to not slice at all (i.e., the thickness is close to zero, zero, or less than zero). FIGS. 14 and 15 best illustrate the blade assembly 102 in one operational configuration, when the device 100 is configured to slice food items to a maximum thickness.

The thickness of the slice corresponds to the vertical spacing between the top surface 138 and a movable surface 156. A blade 158 is mounted to the blade assembly 102 in a fixed relationship with the top surface 138. The illustrated blade 158 is mounted on an edge of the top surface 138 adjacent the movable surface 156, and its sharpened, cutting edge is directed toward the movable surface, in the direction of the proximal end 110 of the blade assembly 102 and device 100. As a result, the illustrated device 100 slices the food item when the handle 112 and blade assembly 102 are pulled. Traditional mandolin slicers, by comparison, cut by pushing the food. The illustrated device 100 holds the food stationary and the operator pulls on the blade 158 (via the handle 112). One of ordinary skill in the art, having reviewed this entire disclosure, will appreciate that this isn't the only configuration, but that the blade 158 could be oriented the opposite direction, such that the blade cuts when the handle 112 is pushed. This and other changes could be made to the illustrated embodiment without deviating from the spirit of the invention.

The movable surface 156 corresponds to the upper surface of a movable module 160 mounted in the blade assembly 102 to move upwards and downwards between and relative to the side rails 124. As best illustrated in FIGS. 11 and 15, the movable module 160 is made up primarily of a carriage 162, a French fry insert 164, a set of French fry blades 166, a cover 172 and a locking mechanism 174. The movable module 160 rides on opposing tracks 176 on the interior surfaces of the side rails 124. Complementary tracks or other features on the opposing sides of the movable module 160 mate with the tracks 176 and allow the movable module to slide up and down with respect to the side rails 124. An individual of ordinary skill in the art will appreciate that other structures can be used to allow the movable module 124 to adjust without deviating from the spirit of the invention.

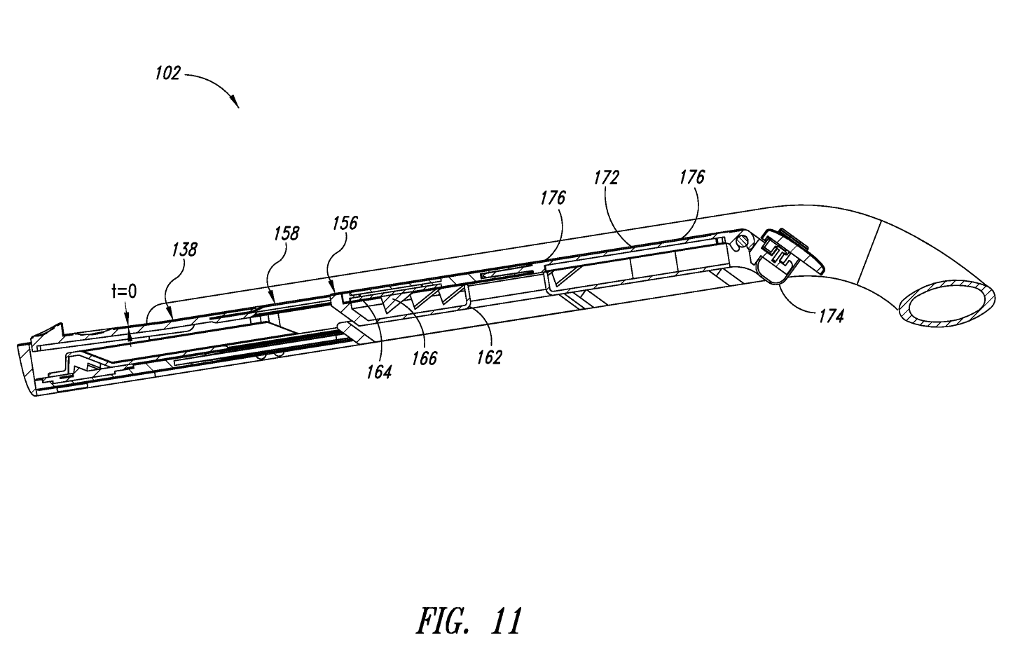

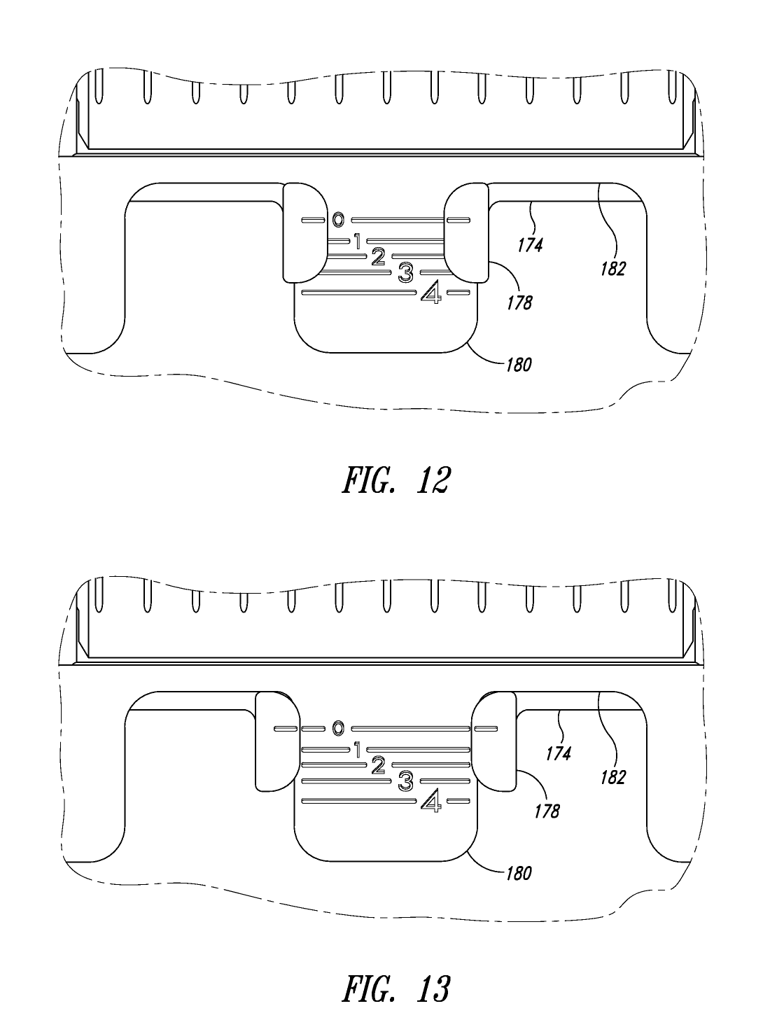

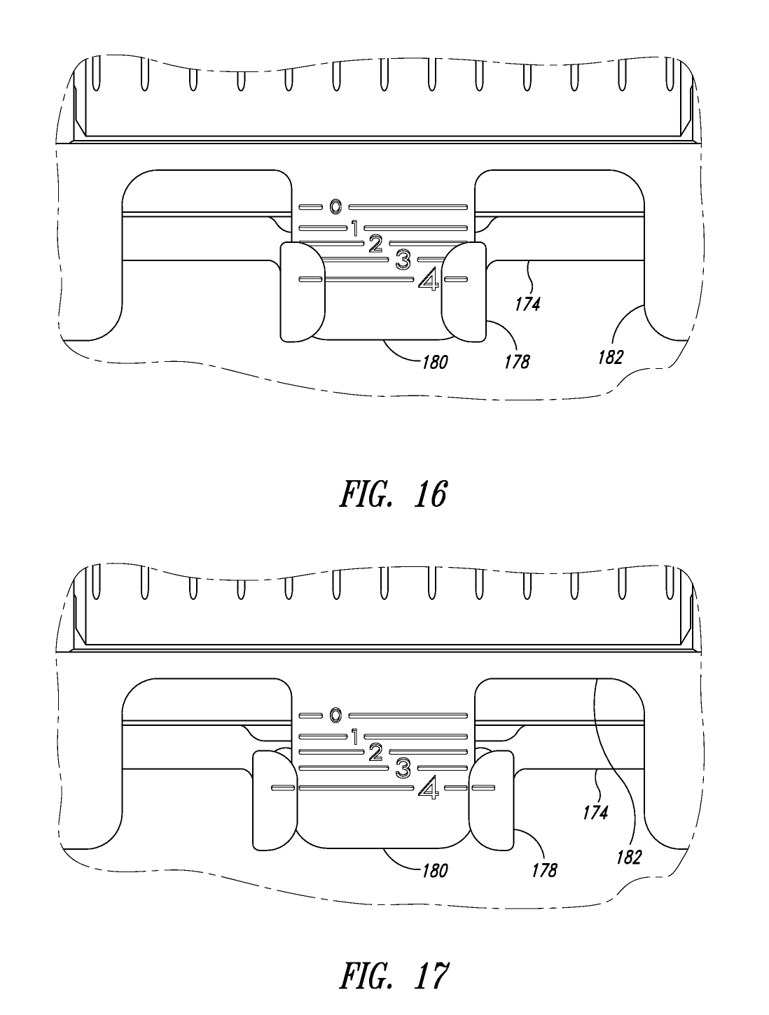

An opposing pair of actuators 178 are mounted on the locking mechanism 174 and readily accessible to the operator. The operator can pinch the actuators 178 between a finger and a thumb, then can slide the actuators up and down a length of a tongue 180 on a bridge 182 between the two side rails 124. The illustrated tongue 180 has demarcations on it, corresponding to the thickness of the slice to be made in that particular configuration. FIGS. 12 and 13, for example, show the actuators 178 aligned with a “0”, an indication that the device 100 is configured for not cutting. FIGS. 16 and 17 show the actuators 178 aligned with the largest symbol, an indication that the device 100 is configured for making the thickest slice. Between the indicators of no cutting and maximum cutting are other, interim designations for making slices of varying thicknesses between the maximum and minimum thicknesses. By releasing the actuators 178, the operator can lock the device 100 in the desired configuration. The locking mechanism 174 can be spring-loaded into a locked position with a pin/detent type lock, wherein squeezing the actuators 178 overcomes the spring force and retracts the pins from the detents. Other suitable locking mechanisms could be used without deviating from the spirit of the invention. FIG. 16 shows the actuators 178 depressed and moved into the maximum configuration, and FIG. 17 shows the device locked in the maximum configuration after the actuators have been released.

The illustrated tongue 180 is oriented roughly parallel to the tracks 176. Because the actuators 178 are attached to the movable module 160, movement of the actuators along the tongue 180 results in movement of the movable module and, along with it, the movable surface 156.

When the movable surface 156 moves downwards as the movable module 160 slides along the tracks 176, the vertical spacing between the blade 158 and the movable surface 156 increases. Slices made by the device 100 are thicker when the spacing is greater. In FIG. 15, where the space is greatest, the thickness “t” of the slice is at a maximum, “T”. When the movable surface 156 moves upwards as the movable module 160 slides along the tracks 176, the vertical spacing between the blade 158 and the movable surface 156 decreases so that slices made by the device 100 are thinner. In FIG. 11, where the space is zero, the thickness t is 0.

FIGS. 7, 9 and 11 illustrate the blade assembly 102 configured for slicing (without regard to thickness). FIGS. 14 and 15, for purposes of comparison, illustrate reconfiguration of the device 100 for cutting French fries, julienne cutting (as the “French fry blades are not necessarily drawn to scale), and the like. As indicated above, the movable surface 156 is made up of, among other things, the French fry insert 164 and the cover 172. The French fry blades 166 project out of the French fry insert 164 from a face opposing the movable surface 156. Accordingly, inverting the French fry insert 164 exposes the French fry blades 166.

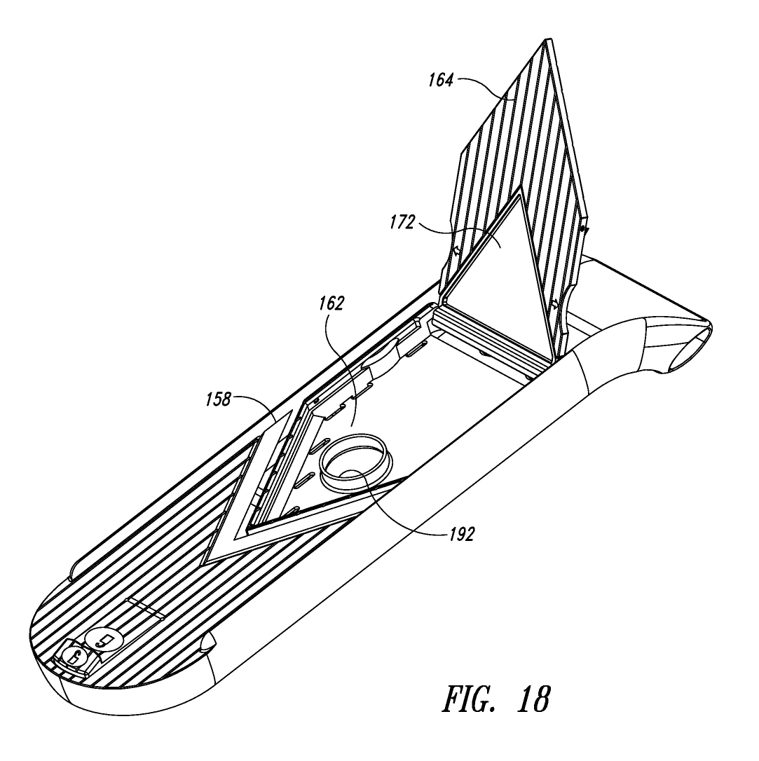

To reconfigure the device 100 from slicing to cutting French fries, julienne cutting, or the like, the French fry insert 164 must be inverted. First, the cover 172 and the French fry insert 164 are rotated, as a unit, at a hinge 184 on the cover 172 about a pin 186 on the carriage 162. After the cover 172 and French fry insert 164 are rotated away from the blade 158, as illustrated in FIG. 18, the French fry insert 164 can be removed from the cover 172. A tongue or ridge 188 on an edge of the cover 172 is slidably received in a complementary slit or groove 190 in a mating edge of the French fry insert 164. Because the ridge 188 and the groove 190 can be held together through an interference fit, the French fry insert 164 can merely be pulled off the cover 172, inverted, and slid back onto the cover. To initially rotate the French fry insert 164 and the cover 172 away from the blade 158, the operator can insert a finger through an opening 192 in the carriage 162 and push directly on a bottom surface of the cover 172.

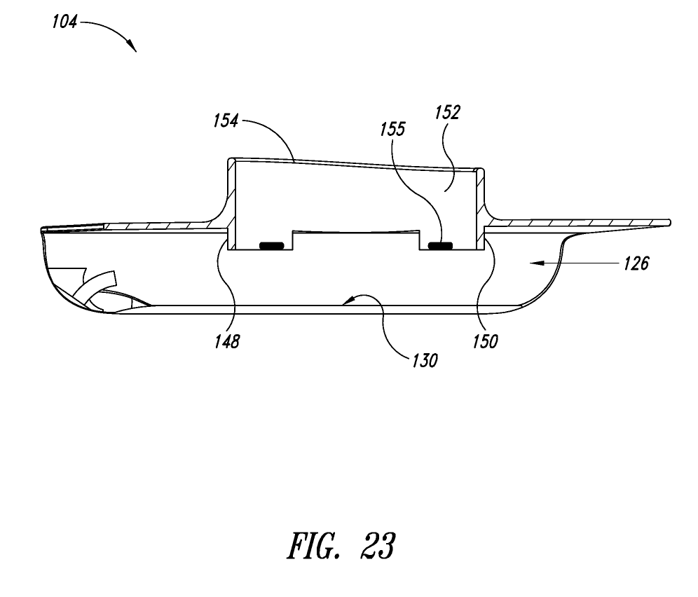

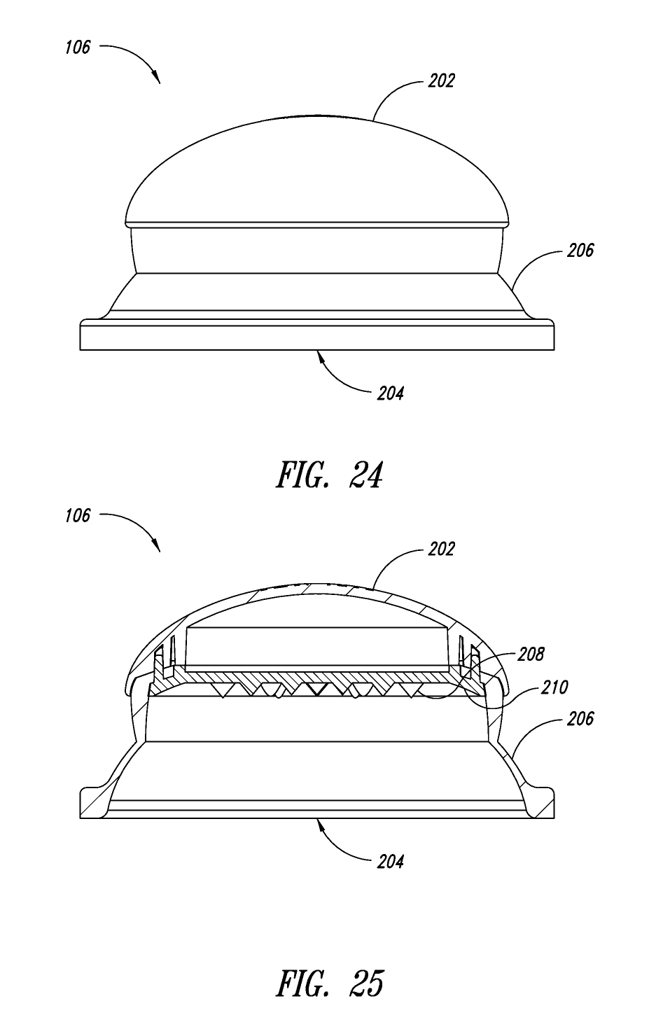

FIGS. 24-27 further illustrate the food depressor 106. The food depressor 106 generally is made up of a cap 202, a rim 204 and a spring 206. The cap 202 is at the top of the food depressor 106, and is the portion that is depressed by the operator during use. The rim 204 is at the bottom of the food depressor 106. The spring 206 connects the cap 202 to the plate 204. Prongs 208 on an interior surface 210 of the cap can urge and hold the food item against the blade assembly 102 during use. The spring 206 is designed to compress under the force of a user pressing on the cap 202.

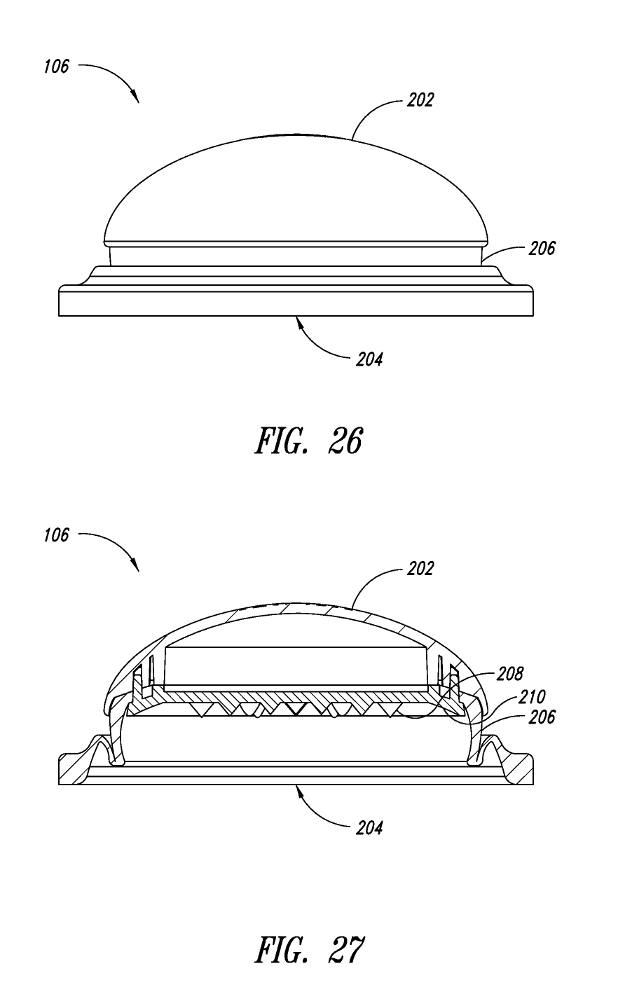

FIGS. 24 and 25 show the food depressor 106 in an uncompressed state. The food depressor 106 is in this state when the cap 202 is not pressed. FIGS. 26 and 27 show the food depressor 106 in a compressed state. The food depressor 106 is in this state when the operator pushes the cap 202 downward as far as possible. As the food depressor 106 moves downward, eventually the rim 204 will contact the protuberances 155 on the circular wall 152, at which point the rim 204 will not move further. As the individual continues to put pressure on the cap 202, the spring 204 will compress and the food item will continue to be urged against the movable blade assembly 102. An individual of ordinary skill in the art, having reviewed this entire disclosure, will immediately appreciate that the structure of the food depressor 106 can be modified without deviating from the spirit of the invention.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A hand-operated device for use in slicing a food item, the device comprising:
a housing having a top, opposing lateral sides, and a food receiving chamber, the housing having a passageway extending longitudinally therethrough between the opposing lateral sides, the passageway being aligned with a slicing plane, the food receiving chamber being accessible through the top of the housing, the food receiving chamber being configured to at least substantially encircle the food item in the slicing plane;
a base fixedly coupled with respect to the housing to support the housing on a countertop or other surface such that the housing does not move during use; and
a blade assembly having a proximal portion, an opposing distal portion, and an upper surface with a blade thereon, the proximal portion of the blade assembly having a handle, the distal portion of the blade assembly being reciprocally engaged with the passageway, the blade assembly being configured to reciprocate with respect to the housing along a slicing stroke longitudinally along the passageway, the blade being located on the upper surface of the blade assembly in a location that passes through or adjacent the food receiving chamber each stroke of the blade assembly.

2. The device of claim 1, further comprising a food depressing member positionable within the food receiving chamber and adapted to urge the food item toward the blade assembly during use.

3. The device of claim 1 wherein the upper surface of the blade assembly comprises a fixed surface and a movable surface, the blade being attached to the fixed surface, the removable surface being adjustable in a direction perpendicular to the surface to increase and decrease the thickness of a slice of the food item being cut by the blade.

4. A hand-operated device for use in slicing a food item, the device comprising:
a housing having a top, opposing lateral sides, and a food receiving chamber, the housing having a passageway extending longitudinally therethrough between the opposing lateral sides, the passageway being aligned with a slicing plane, the food receiving chamber being accessible through the top of the housing, the food receiving chamber being configured to at least substantially encircle the food item in the slicing plane;
a base fixedly coupled with respect to the housing to support the housing on a countertop or other surface such that the housing does not move during use; and
a blade assembly having a proximal portion, an opposing distal portion, a fixed upper surface with a blade thereon, and a movable upper surface, the proximal portion of the blade assembly having a handle, the distal portion of the blade assembly being reciprocally engaged with the passageway, the blade assembly being configured to reciprocate with respect to the housing along a slicing stroke longitudinally along the passageway, the blade being located on the fixed upper surface of the blade assembly in a location that passes through or adjacent the food receiving chamber each stroke of the blade assembly, the movable upper surface being movable vertically with respect to the blade assembly to change a vertical distance between the movable upper surface and the blade and, as such, the thickness of the slice of food item cut by the device.

5. The device of claim 4, further comprising a carriage and a locking actuator, the carriage being slidably mounted to the blade assembly to move vertically with respect thereto, a top surface of the carriage being coincident with the movable upper surface, the locking actuator being coupled between the carriage and the blade assembly to allow the operator to selectively lock the carriage to prevent movement of the movable upper surface and to unlock the carriage to allow for movement of the movable upper surface.

6. A hand-operated device for use in slicing a food item, the device comprising:
a housing having a top, opposing lateral sides, and a food receiving chamber, the housing having a passageway extending longitudinally therethrough between the opposing lateral sides, the passageway being aligned with a slicing plane, the food receiving chamber being accessible through the top of the housing, the food receiving chamber being configured to at least substantially encircle the food item in the slicing plane;
a base fixedly coupled with respect to the housing to support the housing on a countertop or other surface such that the housing does not move during use; and
a blade assembly having a proximal portion, an opposing distal portion, and an upper surface with a blade thereon, the proximal portion of the blade assembly having a handle, the distal portion of the blade assembly being reciprocally engaged with the passageway, the blade assembly being configured to reciprocate with respect to the housing along a slicing stroke longitudinally along the passageway, the blade being located on the upper surface of the blade assembly in a location that passes through or adjacent the food receiving chamber each stroke of the blade assembly, at least a portion of the upper surface being removable and invertable with respect to the blade assembly, the opposing face of the upper surface having a plurality of blades thereon such that, when the upper surface is inverted, the device can make French fry cuts, julienne cuts or the like.

7. The device of claim 6 wherein at least two portions of the upper surface are independently removable and invertable with respect to the blade assembly, the opposing face of a first portion having a plurality of French fry cutting blades thereon and an opposing face of a second portion having a plurality of julienne cutting blades thereon.

8. A hand-operated device for use in slicing a food item, the device comprising:
a housing having a top, opposing lateral sides, and a food receiving chamber, the housing having a passageway extending longitudinally therethrough between the opposing lateral sides, the passageway being aligned with a slicing plane, the food receiving chamber being accessible through the top of the housing, the food receiving chamber being configured to at least substantially encircle the food item in the slicing plane;
a base fixedly coupled with respect to the housing to support the housing on a countertop, bowl, or other surface, such that the housing does not move during use; and
a blade assembly having a proximal portion, an opposing distal portion, and an upper surface with a blade thereon, the proximal portion of the blade assembly having a handle, the distal portion of the blade assembly being reciprocally engaged with the passageway, the blade assembly being configured to reciprocate with respect to the housing along a slicing stroke longitudinally along the passageway, the blade being located on the upper surface of the blade assembly in a location that passes through or adjacent the food receiving chamber each stroke of the blade assembly, the blade being oriented with a cutting edge directed toward the handle such that the device slices the food item each time the operator pulls the blade assembly past the food receiving chamber.
